(19) United States
(12) Patent Application Publication
(10) Pub. No.: US 2006/0065205 A1
(43) Pub. Date: Mar. 30, 2006

(54) Aquarium backup life support system

(76) Inventor: Alberto Venezia, Boca Raton, FL (US)

Correspondence Address: MR. ALBERTO J. VENEZIA, 18642 CAPE SABLE DRIVE, BOCA RATON, FL, 33498, US

(21) Appl. No.: 10/952,490

(22) Filed: Sep. 28, 2004

(51) Int. Cl. A01K 63/00

(52) U.S. Cl. 119/245

(57) ABSTRACT

The Aquarium Backup Life Support System provides a method of delivering air and circulation to an aquatic environment that does not rely on pumps, batteries or chemicals. The system utilizes a source of compressed air that is delivered into the aquarium or container transporting live aquatic animals in the form of automatic bursts of air that deliver oxygen, circulate the water and provide gas exchange to aid in the elimination of carbon dioxide. The duration, volume and timing of the automatic bursts of air can be preset or controlled. This automatic delivery of air enables an interchangeable tank of compressed air to provide long-lasting life support to an aquatic environment. The automatic delivery of the bursts of air may be initiated by a solenoid valve that senses a loss of power to the aquarium system.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING A TABLE OR A COMPUTER PROGRAM LISTING COMPACT DISK APPENDIX

Not applicable

### BACKGROUND OF THE INVENTION

For as long as people have been collecting, transporting, storing and keeping live aquatic animals there has been a need for treating the water that houses these animals. Water that contains these animals—whether for transportation or temporary care or long-term care—must have adequate levels of oxygen and circulation to promote gas exchange; i.e., the removal of carbon dioxide from the water. For the long term life and health of aquatic animals, filtration and the removal of harmful chemical compounds are necessary.

The field of endeavor to which the invention pertains is the method of providing a backup system of aeration and circulation to the aquarium system or for the transportation of aquatic animals.

Electricity is widely used to operate pumps, filters, aerators and many other devices that operate transportation and aquarium systems that help sustain the life of aquatic animals for trade and recreation. However, inevitably electricity fails, batteries die, power outages happen and technical difficulties occur. During the course of these events, aquatic animals that rely on electrically driven technology for aeration and circulation are put at risk. This is illustrated by the loss of whole aquarium systems during power outages.

The backup systems of the prior state of the art rely on batteries to operate electrically driven air pumps that send a steady stream of air bubbles thru the water, when power fails and the pump of the filter system stops. This method of backup is limited because strong circulation is not created to move larger portions of water, effecting gas exchange and the removal of carbon dioxide. Furthermore, batteries that sit in the backup device for long periods of time often weaken, die or corrode, rendering the device useless.

In systems that aid in transporting aquatic life, pumps and aerating equipment are expensive to run, ultimately wear out and require a great deal of maintenance resulting from the harsh environments in which they must perform. Breakdown of these systems during transit often results in great economic loss and public health hazards in the death of these transported animals.

Recently the use of chemicals that absorb carbon dioxide and degrade to release oxygen have been used for the transportation of live aquatic animals. This method of life support is expensive and requires proper storage and a constant continuing supply of chemical products. In addition, the introduction of chemicals is not automatic and not practical as a backup system for home aquarium systems or for aquariums for public display.

It becomes apparent that what is needed is a new method of backup system that addresses the problems and inefficiencies of the backup systems of the prior state of the art. It is to this need that the invention is drawn. The invention is fully adjustable, does not rely on the use of constant electricity, utilizes no pump or battery or chemical, can operate for long periods of time, has indefinite shelf life, can be recharged and requires no maintenance.

A search of the prior art did not disclose any patents that read directly on the claims of the invention; however, for background purposes and as indicative of the art to which the invention relates, reference may be made to the following patents found in the search:

| U.S. PAT. NO. | DATE ISSUED | INVENTOR | CLASS/SUBCLASS |
|---|---|---|---|
| 4034030 | July 1977 | Bracey | 261/64 |
| 4101607 | July 1978 | Bart | 261/36 |
| 5054423 | October 1991 | Escobal | 10/1991 |
| 5458771 | October 1995 | Todd | 210/220 |
| 5480590 | January 1996 | Neshat et al. | 261/30 |
| 5876639 | March 1999 | Campau | 261/36.1 |
| 5988601 | November 1999 | Burgess | 261/34.1 |
| 6523498 | February 2003 | Shyu | 119/259 |

### BRIEF SUMMARY OF THE INVENTION

The Aquarium Backup Life Support System resolves the problems and inefficiencies of the backup systems of the prior art. When the aquarium loses power the backup system immediately starts to send into the aquarium periodic controlled automatic bursts of air from a tank of compressed air. These timed bursts of air meet the oxygen requirements of the aquarium and create turbulence and circulation inside the aquarium to provide gas exchange and aid in the release of carbon dioxide from the water. Since the duration of the bursts are preset and timed, it is possible to have one tank of compressed air of specific oxygen content deliver bursts for exceptionally long periods of time. Spare tanks may be kept on hand for even longer usages.

The backup system maintains a level of oxygen in the aquarium and provides gas exchange without the use of power. The backup system is comprised of a tank of compressed air, a manifold of air valves and controls and a hose that is installed in the aquarium. A solenoid valve on the manifold is plugged in where the pump of the aquarium is plugged in and is constantly energized, keeping the valve closed and the pressurized air in the tank. Upon a power outage the solenoid is de-energized and the valve is opened by an internal spring. This leads to the activation of valves in the system that direct and control specifically timed releases of adjustable volumes of air that operate valves that determine and create the timed bursts of air and circulation in the aquarium. With the initial deactivation of the solenoid valve, a logical loop of air flow commences and the backup system begins to work automatically according to the set controls. When power is restored the solenoid is reenergized and the system shuts off until its next use.

This method of releasing preset and timed automatic volumes of compressed air into the water eliminates the use of electrically driven pumps or battery operated pumps that perform backup operations for the aquarium, or for the transportation of aquatic life. The elements of the system are waterproof and require little or no maintenance. Tanks may be stored for long periods of time and are swapped out easily and inexpensively. The system uses no chemicals and requires no experience to operate beyond the simple adjustment of it settings.

### BRIEF DESCRIPTION OF THE SEVERAL VIEWS OF THE DRAWING

FIG. 1 is a schematic view of the Aquarium Backup Life Support System.

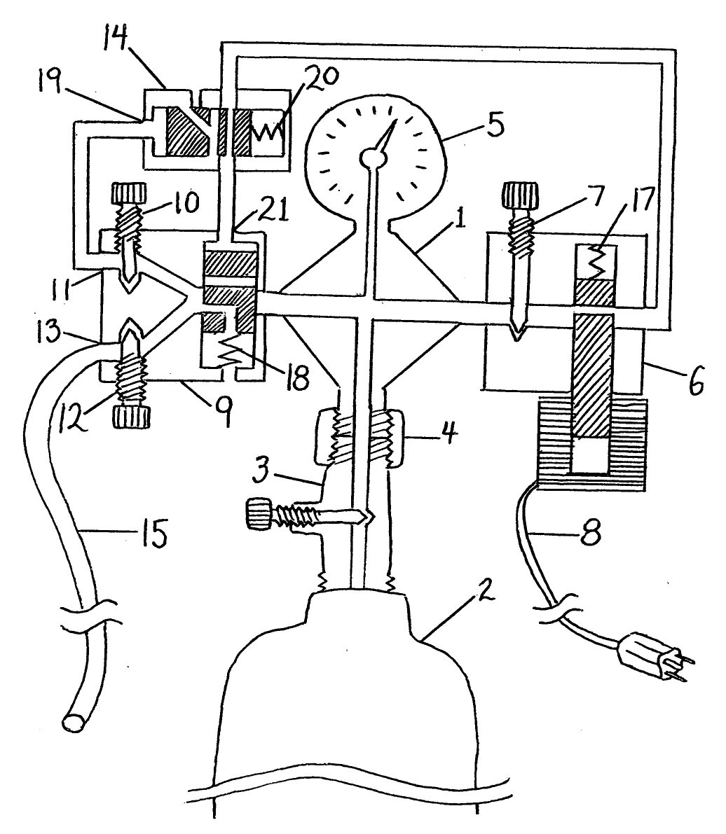

FIG. 2 is a general perspective view of the Aquarium Backup Life Support System.

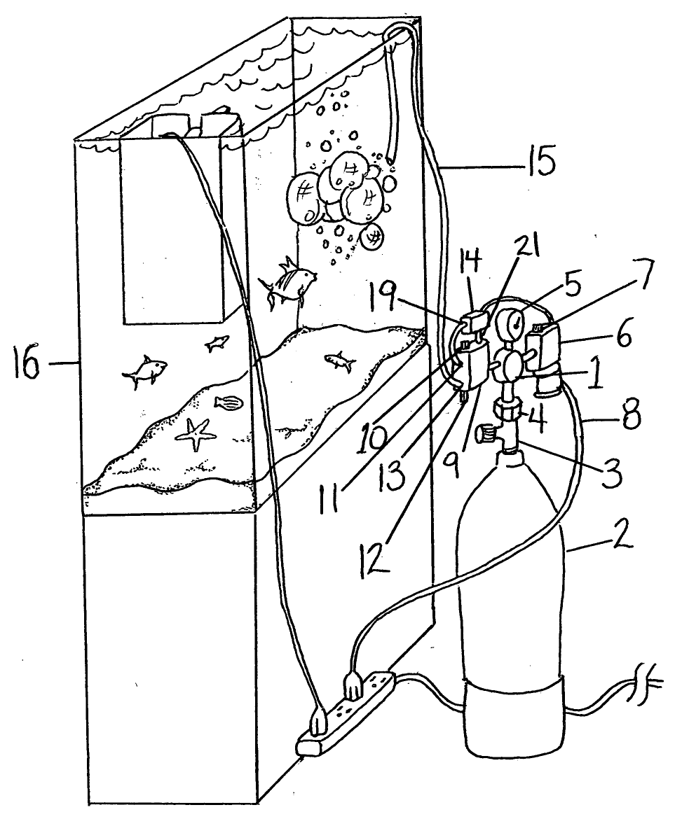

### DETAILED DESCRIPTION OF THE INVENTION

The overall components comprising the invention are the manifold (1) and the air tank (2) with valve (3) and connector (4). Connected to the manifold is a gauge (5), a solenoid valve (6) with pressure reducer (7), electric cord (8), a main valve (9) with a flow and speed control (10) on the upper exit port (11) and a flow and speed control (12) on the lower exit port (13), a secondary valve (14), and an air hose (15).

The invention is plugged into the power that runs the aquarium. The air hose of the system is installed inside the aquarium (16). With the tank full of compressed air and the valve of the tank (3) open, pressurized air from the tank is at the solenoid valve (6). The solenoid valve is plugged into the same power source that runs the aquarium. This keeps the solenoid valve in an energized state. The solenoid valve is normally open by an internal spring (17). When it is in the energized state it stays closed. If the power to the aquarium fails the solenoid valve de-energizes and opens, allowing the air of the tank to pass thru the pressure reducer (7) and on thru the secondary valve (14) and then into the pilot port of the main valve (21).

The main valve is normally closed by an internal spring (18). The pressurized air from the solenoid flowing thru the secondary valve acts as a pilot control and opens the main valve and remains at pressure keeping the main valve open. When the main valve opens, high pressure air is sent from the air tank thru two exit ports—an upper port (11) and a lower port (13)—simultaneously. The high pressure air from the lower port travels thru a flow and speed control (12) and on thru the air hose (15) and into the aquarium water creating a burst of air.

At the same time that the air is traveling out of the lower exit port it is also traveling out the upper exit port. From the upper port the high pressure air travels thru the flow and speed control and into the pilot port of the secondary valve (19). The secondary valve is normally open by way of an internal spring (20). This flow of pressurized air from the upper port of the main valve acts as a pilot control and shuts the secondary valve, overcoming its internal spring and prevents the pressurized air from the solenoid valve from entering the pilot port of the main valve (21). At the same time of the closing of the secondary valve the pilot pressure in the main valve is vented and causes the main valve to close immediately from its internal spring, stopping the burst of air in the aquarium. As the main valve closes, the pressurized air that acts as the pilot control for the secondary valve vents out and the internal spring of the secondary valve opens the valve thus allowing the air from the solenoid to start to build and over a period of time open the main valve to start the cycle over again, creating automatic periodic bursts of air into the aquarium. The automatic periodic bursts will continue until power is restored and the solenoid shuts or until the tank of compressed air runs out.

The time it takes for the air from the solenoid valve to build and open the main valve is determined by the pressure reducer of the solenoid valve. Adjustment of this control will determine how often the bursts of air are initiated. The speed and volume controls on the upper and lower exit ports of the main valve determine the duration of the burst of air released into the aquarium. When the controls are set, where the upper is open more than the lower, the shortest duration of burst will be provided. When the lower control is open more than the upper control, a longer duration of burst will be provided. These controls, along with the pressure reducer of the solenoid valve, are set according to the specific application. The size and population of the aquarium or the volume of contained water (if the system is used to transport aquatic animals) all become factors that will determine how the controls are set.

The specific activities of the invention create a method of aeration and circulation that uses compressed air optimally released to maximize the life support qualities of oxygen saturation and gas exchange within a container where aquatic animals are kept. More specifically, the invention serves as a backup system for aquariums when they lose electricity or when a pump breaks down and a replacement is not immediately available. By utilizing compressed air and valves for operation, the invention solves the problems and inefficiencies of the backup systems and transportation, circulation and oxygen delivery systems of the prior art.

Scuba air tanks are an excellent choice for the tank element of the system and the manifold and valve portion of the system can easily be swapped to new filled tanks for indefinite use of the system. If the system is used solely for transportation, one embodiment of the invention leaves the solenoid valve off the manifold and the air tank valve turns the system on or off.

While the preceding descriptions are directed to multiple embodiments of the invention, and the invention has been described in complete detail and illustrated in the drawings, it is not to be limited only to those embodiments and details since many changes and modifications may be effected without departing from the spirit and scope thereof. The invention is described to cover any and all modifications, forms and arrangements which may come within the language and scope of the appended claims.

I claim:

1. An Aquarium Backup Life Support System comprising a manifold control and valve assembly whereby a removable means, a source of compressed gases is connected wherein;
the manifold control and valve assembly further comprising at least one gauge of a removable means, where said gauge indicates pressure and volume of said compressed gases source, where connected to said manifold there is an arrangement of valves and controls that automatically disperse, specific, adjustable, bursts of said compressed gases that are by a means initiated and discontinued by the activation of at least one valve upon the failure of power to the aquarium system where said dispersion of specific, adjustable, bursts of compressed gases may by a means be delivered to a body of water where aquatic animals are contained.

2. The Aquarium Backup Life Support System of claim 1 further comprising a circuit of logic that creates a unique adjustable automatic delivery of at least one element or function of life-sustaining quality to aquatic animals.

3. The manifold control and valve assembly of claim 1 further comprising valves and controls of a removable and reconfigurable means where said removal and reconfiguration of said valves and controls create an adjustable automatic circuit where said circuit delivers life-sustaining elements to an aquatic environment.

4. The Aquarium Backup Life Support System of claim 1 wherein said removable source of compressed gases may comprise at least one portable tank with at least one valve where said tank is by a means refillable and interchangeable.
